(19) United States
(12) Patent Application Publication
(10) Pub. No.: US 2020/0286135 A1
(43) Pub. Date: Sep. 10, 2020

(54) Methods, Systems and Devices for Detecting User Interactions

(71) Applicant: Arm KK, Kanagawa (JP)

(72) Inventor: Haribol Matayoshi, Tokyo (JP)

(73) Assignee: Arm KK, Kanagawa (JP)

(21) Appl. No.: 16/610,716

(22) PCT Filed: Apr. 26, 2018
(86) PCT No.: PCT/JP2018/017088

§ 371 Date: Nov. 4, 2019

(30) Foreign Application Priority Data
May 5, 2017 (GB) 1707163.0
Oct. 16, 2017 (GB) 1716919.4

(51) Int. Cl. G06Q 30/02; G09F 3/20; G06K 9/00; G06N 20/00

(52) U.S. Cl. CPC G06Q 30/0281; G09F 3/208; G09F 3/204; G09G 2380/04; G06K 9/00362; G06N 20/00; G06K 9/00221

(57) ABSTRACT

The present techniques generally relate to a method comprising: receiving, at a first resource from an electronic device, a communication comprising sensed data based on or in response to sensing user interactions at the electronic device; processing, at the first resource, the sensed data; transmitting, from the first resource to the electronic device, a first command communication to generate a sensory output at the electronic device in response to sensed data.

The present techniques relate to the field of data processing devices in retail and commercial applications. More particularly, the present techniques relate to methods, systems and devices for detecting user interactions in retail and commercial applications.

Traditional product labels associated with goods in retail and commercial applications comprise paper, which requires manual updating or replacement when data associated with the goods changes (e.g. when a price or barcode is updated).

Furthermore, data relating to user interaction with goods having such traditional product labels may be derived at the point of sale when a customer purchases the goods. However, such information may be limited to the price, quantity and time of sale of the goods.

The present techniques seek to provide improvements to traditional product labels.

According to a first technique there is provided a method comprising: receiving, at a first resource from an electronic device, a communication comprising sensed data based on or in response to sensing user interactions at the electronic device; processing, at the first resource, the sensed data; transmitting, from the first resource to the electronic device, a first command communication to generate a sensory output at the electronic device in response to sensed data.

According to a further technique there is provided a method comprising: generating, at an electronic device, sensed data based on or in response to sensing a user interaction at the electronic device; generating, at the electronic device, a sensory output based on or in response to the sensed data.

According to a further technique there is provided a method of responding to detecting user interactions at an electronic label, the method comprising: sensing, at the electronic label, user interactions; generating, at the electronic label, sensed data based on or in response to the sensed user interactions; generating, using authentication data at the electronic label, a secure communication comprising the sensed data; transmitting, from the electronic label to a remote resource, the secure communication; receiving, at the electronic label from the remote resource, a secure command communication; generating, at the electronic label, a sensory output based on or in response to the secure command communication.

According to a further technique there is provided a system comprising: a first resource in communication with one or more electronic devices, wherein the first resource receives sensed data from the one or more electronic devices, and wherein the first resource transmits a first command communication to one or both of the one or more electronic devices and a user application device based on or in response to processing the sensed data.

According to a further technique there is provided an electronic device comprising: sensor circuitry comprising a sensor to detect a user interaction in proximity thereto, and to generate sensed data in response to the user interaction; processing circuitry to process the sensed data; output circuitry comprising an output device to generate a sensory output; and wherein the electronic device is configured to generate the sensory output based on or in response to processing the sensed data.

According to a further technique there is provided a resource comprising a logic engine to process sensed data received from one or more electronic devices, and to transmit a first command communication to one or both of: the one or more electronic devices and a user application device based on or in response to the sensed data.

According to a further technique there is provided a method of responding to a user interaction with a product in a retail environment, the method comprising: detecting, with one or more cameras associated with a carrier apparatus, the user interaction; generating, with the one or more cameras, image data for the product; identifying the product based on or in response to the image data; determining, at a remote resource, a cost for the product based on or in response to the user interaction with the identified product.

According to a further technique there is provided a system comprising: a carrier apparatus having one or more cameras to detect a user interaction with a product and communications circuitry for wireless communications; and a resource in wireless communication with the carrier apparatus; wherein the one or more cameras are arranged to generate image data for a product in response to detecting a user interaction, and wherein one of the remote resource and carrier apparatus identifies the product based on or in response to the image data and determines a cost of the product.

According to a further technique there is provided a carrier apparatus for a retail environment, the carrier apparatus comprising: one or more cameras arranged to detect a user interaction with a product and to generate image data in response to the user interaction; location determination circuitry, to generate location data for a location of the user interaction; and communication circuitry to pair the carrier apparatus with the user and to transmit the image data and location data to a resource remote therefrom.

According to a further technique there is provided a method of identifying misplaced products in a retail environment, the method comprising: detecting, at a carrier apparatus, a user removing a product from the carrier apparatus; transmitting, from the carrier apparatus to a remote resource, image data for the product and location information indicating the location at which the product is removed; determining, at the remote resource, whether the location at which the product is removed is a correct location for the product; transmitting, from the remote resource to a third party, a signal indicating that the product is misplaced when it is determined the location at which the product is removed is an incorrect location for the product.

According to a further technique there is provided a method of identifying misplaced products in a retail environment, the method comprising: detecting, using sensor circuitry associated with an electronic label, when a product is placed at an incorrect location in the retail environment; indicating, using the electronic label, that the misplaced product is detected, wherein indicating that the misplaced product is detected comprises one or more of: generating a visual or audible output and transmitting a signal to a remote resource.

According to a further technique there is provided a method of analysing user interactions with a plurality of products in a retail environment, the method comprising: sensing, at electronic labels associated with the respective products, user interactions with the respective products; generating, at the electronic label, sensed data based on or in response to the sensed user interactions; transmitting, from the electronic labels to a remote resource, the sensed data; generating, at the remote resource, analytics results based on or in response to the sensed data received from the electronic labels.

The present techniques are diagrammatically illustrated, by way of example, in the accompanying drawings, in which:

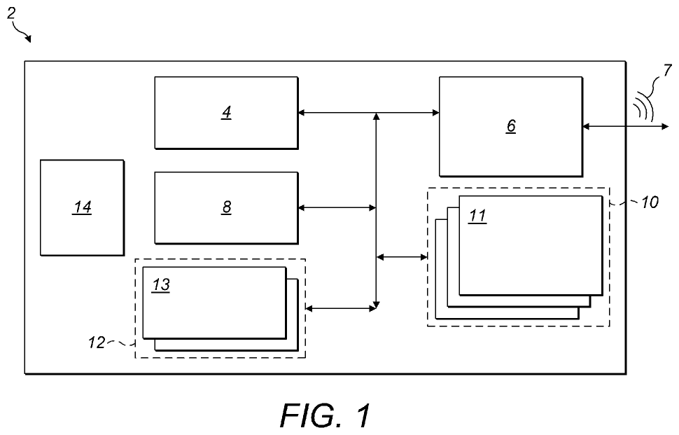

FIG. 1 schematically shows a block diagram of an electronic label according to an embodiment;

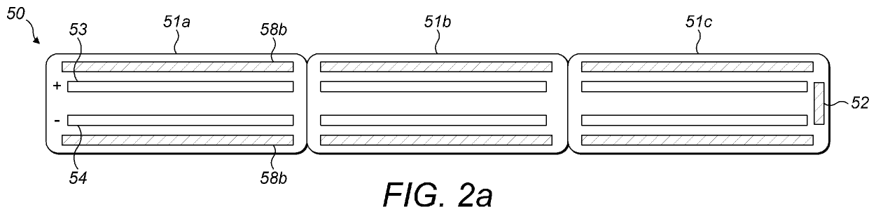

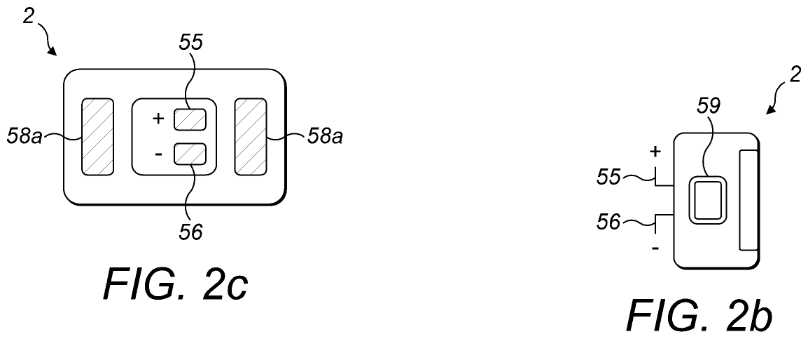

FIG. 2a schematically shows an example power rail for supplying power to the electronic label of FIG. 1;

FIG. 2b schematically shows a side view of an example electronic label having connectors for electrically coupling the electronic label to the power rail of FIG. 2a;

FIG. 2c schematically shows a rear view of the electronic label of FIG. 2b;

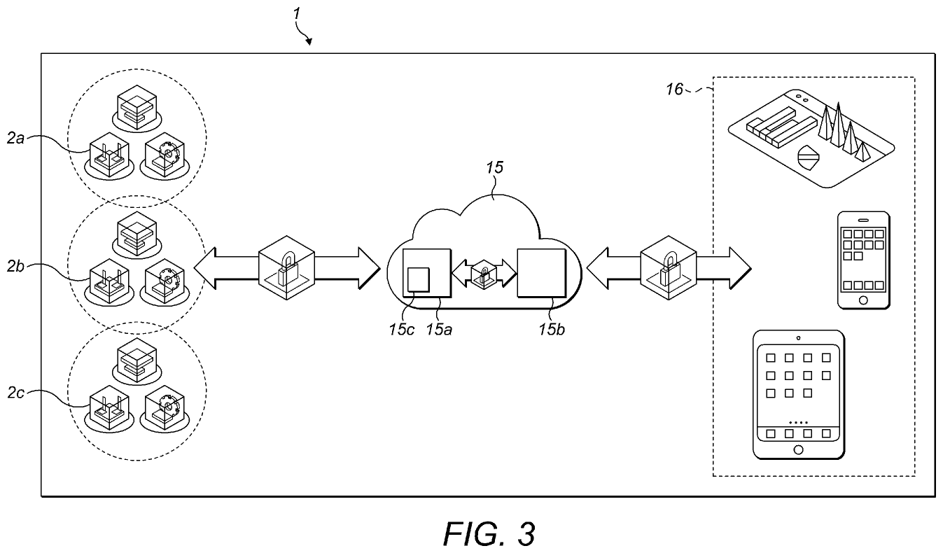

FIG. 3 schematically illustrates a system having electronic labels, services and devices according to an embodiment;

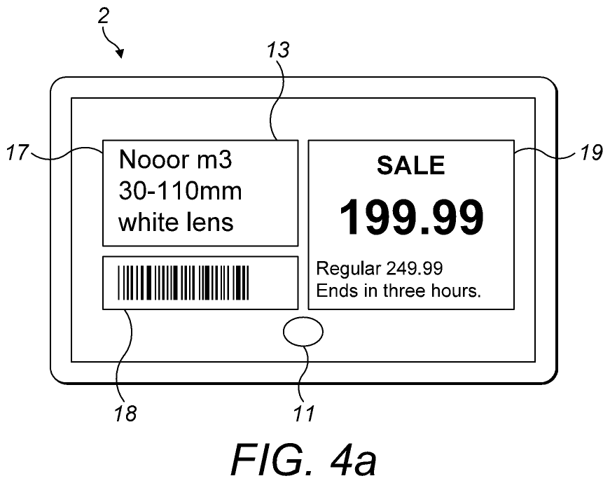

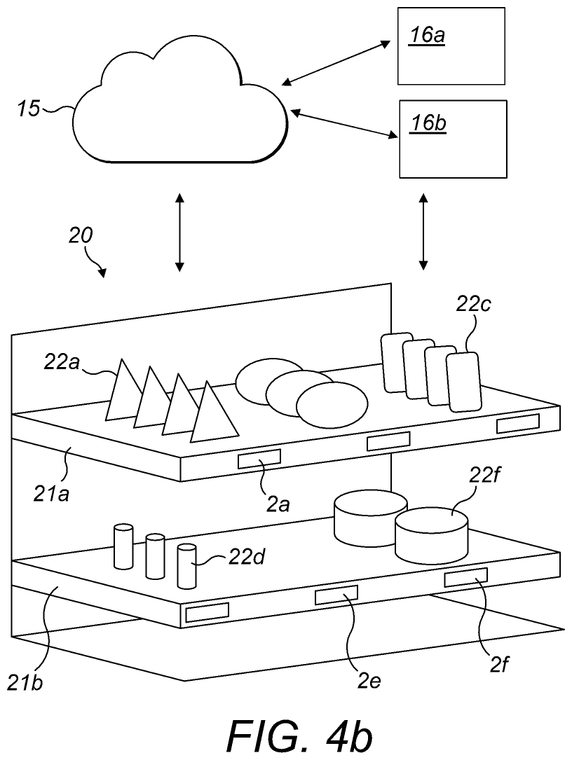

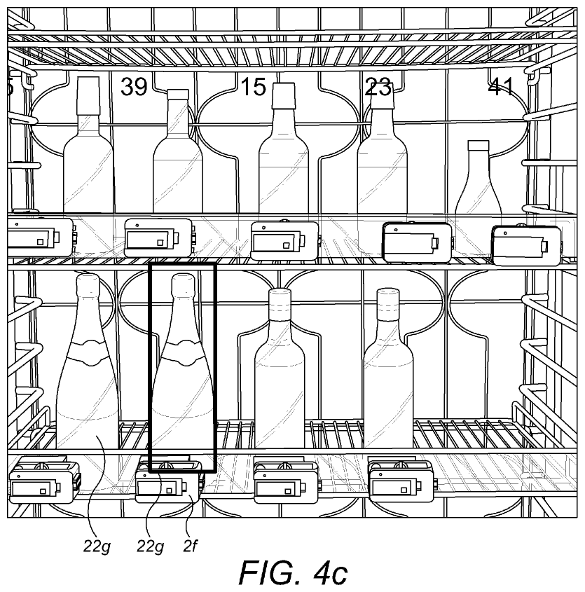

FIG. 4a schematically shows an example front view of the electronic label of FIG. 1;

FIG. 4b schematically shows an example retail environment having a plurality of electronic labels arranged on shelving therein according to an embodiment;

FIG. 4c schematically shows an example retail environment having a plurality of electronic labels arranged on shelving therein according to an embodiment;

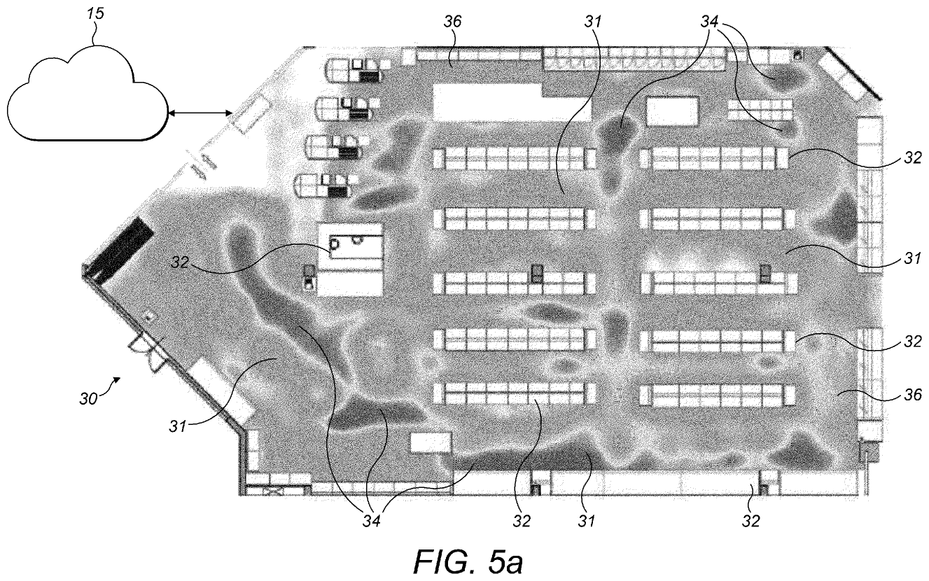

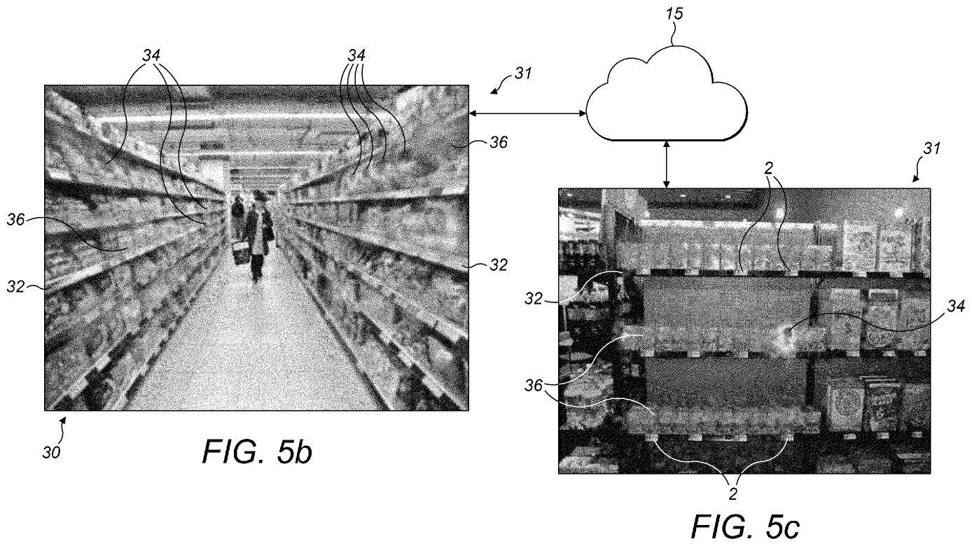

FIG. 5a schematically shows an example retail environment having electronic labels associated with different product lines according to an embodiment;

FIG. 5b schematically shows a single aisle of the retail environment according to an embodiment;

FIG. 5c schematically shows shelving on the single aisle of the retail environment according to an embodiment;

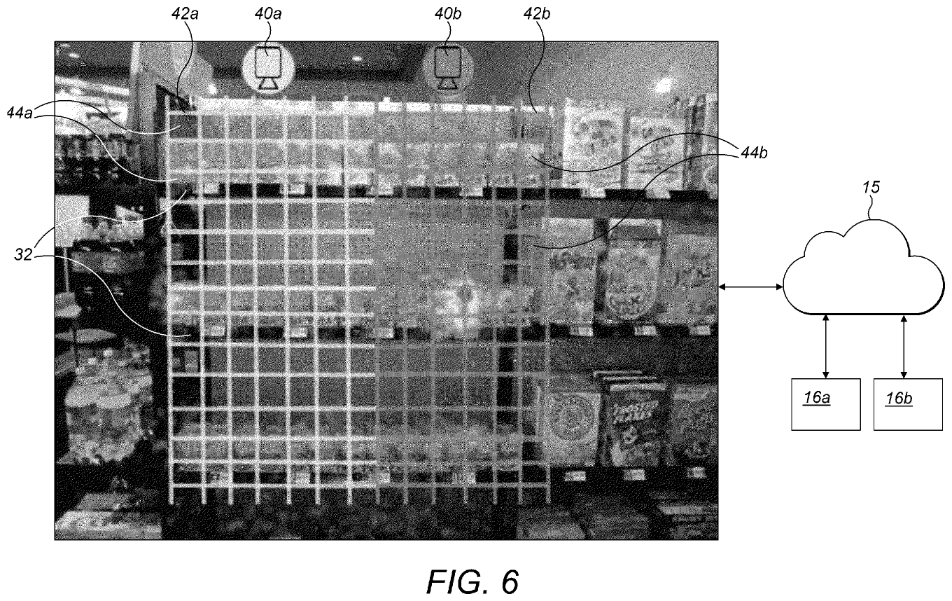

FIG. 6 schematically shows an example of sensor circuitry used to generate sensed data according to an embodiment;

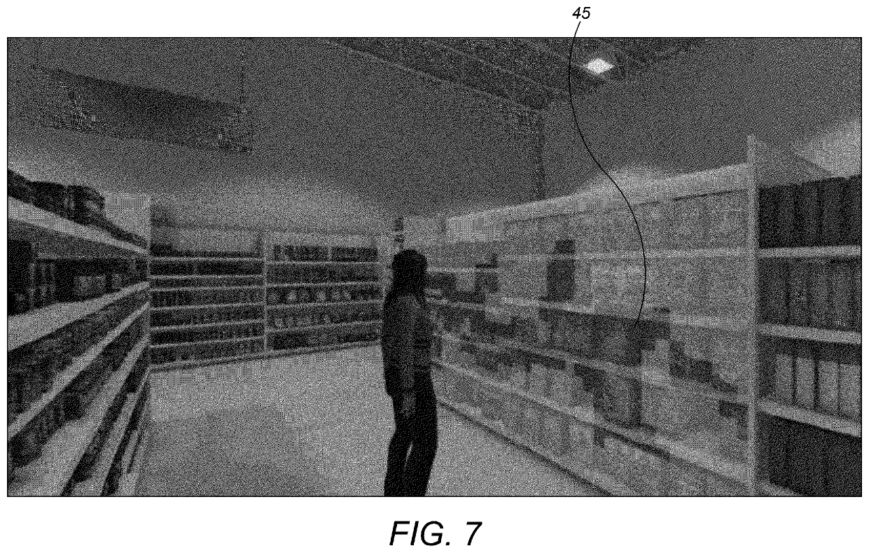

FIG. 7 schematically shows an example of an analytics results according to an embodiment;

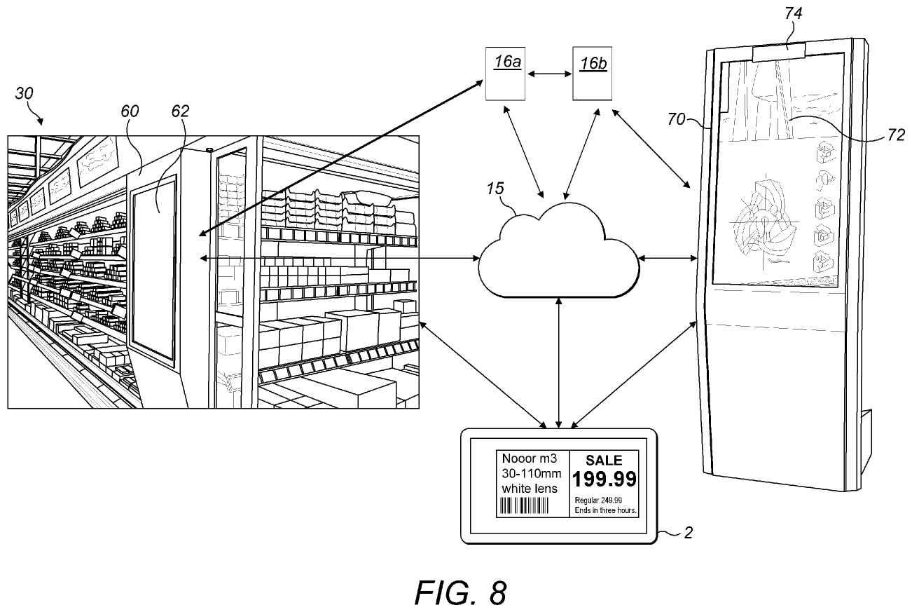

FIG. 8 schematically show examples of electronic signage for use in a retail environment;

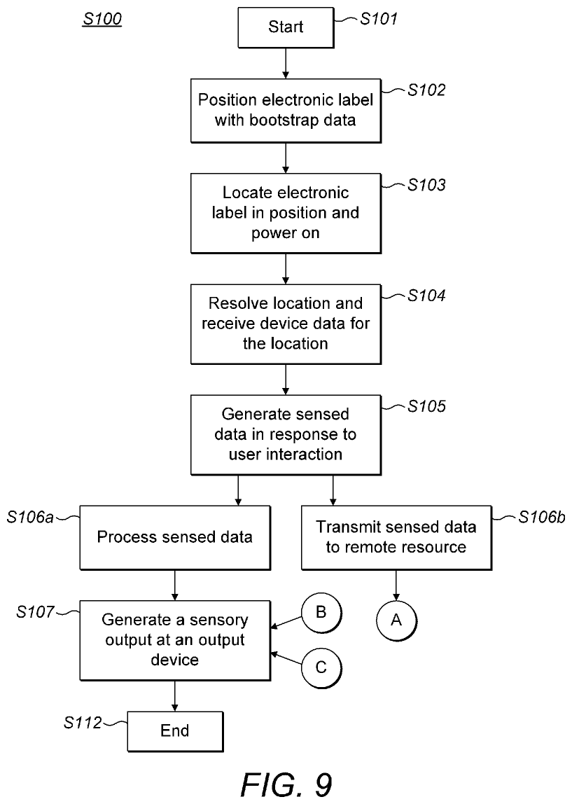

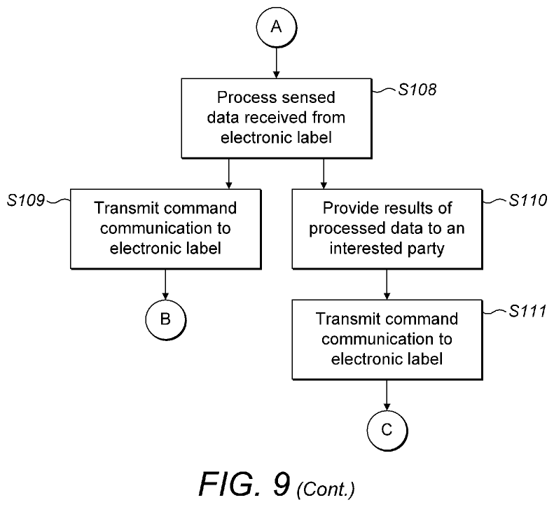

FIG. 9 is a flow diagram of steps in an example lifecycle of the electronic label of FIG. 1;

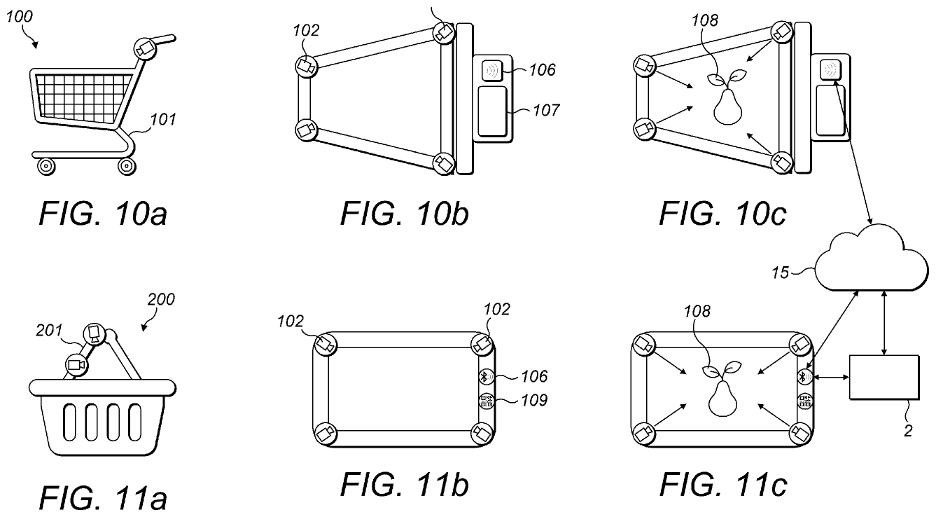

FIGS. 10a-10c schematically show an example of a carrier apparatus for use in a retail environment according to an embodiment;

FIGS. 11a-11c schematically show an example of a carrier apparatus for use in a retail environment according to an embodiment; and

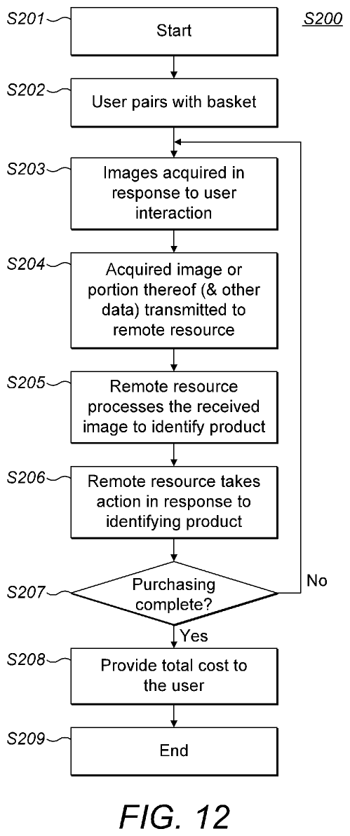

FIG. 12 is a flow diagram of steps in an illustrative process for a user using a carrier apparatus of FIGS. 10a-10c or 11a-11c.

FIG. 1 schematically shows a block diagram of a data processing device 2, such as an electronic shelf label hereafter “electronic label” 2, which may be an electronic device in the Internet of Things (IOT).

The electronic label 2 may be associated with one or more products (e.g. goods or services) at a location in retail or commercial environment such as a retail store (e.g. shop, supermarket etc.) or warehouse, whereby the electronic label may be fixed (e.g. permanently fixed or removably fixed) at a location in proximity to the product (e.g. on a shelf, gantry or otherwise).

The electronic label 2 comprises processing circuitry 4, such as a microprocessor or integrated circuit(s) for processing data and for controlling various operations performed by the electronic label 2. In some embodiments the processing circuitry comprise artificial intelligence (AI) to perform machine learning, deep learning or neural network analysis on the processed device data and may also comprise a logic engine to take an action in response to processing the device data.

The electronic label 2 also has communication circuitry 6 for communicating with one or more resources remote therefrom such as a mobile device, computer terminal, service (e.g. cloud service), gateway device or computing platform (not shown) etc.

The communication circuitry 6 may use wireless communication 7, such as communications used in, for example, wireless local area networks (WLAN) and/or wireless sensor networks (WSN) such as Wi-Fi, ZigBee, Bluetooth or Bluetooth Low Energy (BLE), using any suitable communications protocol such as lightweight machine-to-machine (LWM2M). The communication circuitry 6 may also comprise short range communication capabilities such as radio frequency identification (RFID) or near field communication (NFC),

The electronic label 2 also comprises storage circuitry 8 (e.g. non-volatile/volatile storage), for storing data provisioned on or generated by the electronic label 2, hereafter “device data”.

Such device data includes identifier data comprising one or more device identifiers to identify the electronic label 2 and may comprise one or more of: universally unique identifier(s) (UUID), globally unique identifier(s) (GUID) and IPv6 address(es), although any suitable device identifier(s) may be used.

The device data may also include authentication data for establishing trust/cryptographic communications between the electronic label 2 and a remote resource. Such authentication data may include certificates (e.g. signed by a root authority), cryptographic keys (e.g. public/private key pairs; symmetric key pairs), tokens etc. The authentication data may be provisioned on the electronic label 2 by any authorised party (e.g. by an owner, a manufacturer or an installer).

The electronic label 2 may also be provisioned with, or generate, other device data. For example, the electronic label 2 comprises sensor circuitry 10 having one or more sensors 11 to detect user activity or interactions (e.g. user presence, user movement, user gestures, user communications (e.g. a user bumping its associated device against an NFC tag on the electronic label 2; scanning a code (e.g. a QR code) at a code reader at the electronic label) etc.).

In operation, device data generated by the sensor circuitry, hereafter “sensed data” may be processed by the electronic label 2 to monitor the user interactions or transmitted to a remote resource for processing thereby so as to monitor the user interactions, such that an appropriate action can be taken in response to processing the sensed data.

For a retail environment, the sensor circuitry may be configured to detect user interaction within 0-100 cm of the associated product, although the claims are not limited in this respect.

The sensor circuitry to detect user interaction may comprise an optical or acoustic motion sensor.

The sensor circuitry to detect user interaction may also comprise a camera provided on the electronic label 2 or which may be arranged remote from the electronic label 2 but in communication therewith (e.g. via wireless or wired communication). As described below, the camera may be used to detect a user interaction with a product or product line. Furthermore, the camera may have facial recognition, facial detection or body feature recognition capabilities to detect one or more characteristics of the user (e.g. using a camera vison system). Such characteristics may include the user's gender, age, height, shoe size, weight, waist size, hairstyle, gait, clothes worn by the user etc., although the claims are not limited in this respect. The camera may also detect user gestures using a time-of-flight (TOF) sensor. In some examples, the camera may comprise a computer vision system.

The sensor circuitry 10 may additionally, or alternatively, comprise a further sensor to monitor the product with which the electronic label is associated. For example, such a sensor may comprise a weight sensor to detect variations in the weight of an associated product(s), so as to detect, for example, whether a user picks up, touches, and/or replaces the associated product. Such a sensor may also comprise a motion sensor to detect when a product is picked up or touched by a user.

The sensor circuitry 10 may additionally, or alternatively, comprise sensors to detect changes in the environment local to the electronic label such as a light, humidity and/or temperature sensors.

The sensor circuitry 10 may additionally, or alternatively, include the communications circuitry 6 to detect user interactions with the electronic label 2 via a device associated with the user (hereafter “user application device”). Such a user application device may comprise a mobile phone, tablet or smart device such as a smart watch, whereby the sensed data may be generated when the user actively communicates with the electronic label 2 via the user application device (e.g. via NFC, RFID, Bluetooth etc), or whereby the electronic label senses one or more wireless signals generated by the user application device when the user application device is in proximity thereof.

The electronic label 2 also comprises output circuitry 12, whereby the output circuitry 12 comprises one or more output devices to generate sensory outputs (e.g. visual or audible outputs) to which a user can react. Such a reaction may comprise the user performing an action, such as picking up the associated product(s), replacing the product or scanning a code (e.g. QR code) for offline interaction. It will be appreciated that this list of actions is illustrative only.

In examples, an output device may comprise one or more lights (e.g. light emitting diodes (LED)), or an output device may comprise a display such as an OLED (organic LED) display, LCD (liquid crystal display) or an electronic ink (e-ink) display. An e-ink display may be preferred in some applications due to the wide viewing angle, reduced glare and relatively low power consumption in comparison to the OLED and LCD displays.

Additionally, or alternatively, the output device may comprise a speaker for emitting a sound (e.g. a buzzer, song or spoken words).

Additionally, or alternatively, the output circuitry 12 may utilise the communications circuitry 6 as an output device to transmit communications comprising targeted messages or content to the user application device to cause a sensory output to be generated thereat.

The electronic label 2 also comprises power circuitry 14 to power the various circuitry and components therein. In examples, the electronic label 2 is powered using a power rail to which the power circuitry is provided in electrical communication. An example power rail is described in greater detail in FIG. 2.

The power circuitry 14 may additionally, or alternatively, comprise a battery, which may be charged (e.g. inductively or otherwise) using, for example, the power rail.

In another example, the power circuitry 14 may include an energy harvester such as a Wi-Fi energy harvester, which may power the electronic label and/or charge the battery.

In operation, the electronic label 2 detects, using the sensor circuitry 10, a user interaction and performs an action in response to the detected interaction.

The sensed user activity or interaction may comprise one or more of: detecting the presence of a user; detecting motion of a user; detecting whether a user picks up and/or replaces a product; measuring the duration a user looks at or examines a product (dwell time); measuring the frequency of users picking up products and/or replacing products; and detecting a gesture towards or away from a product (e.g. tracking eyeball movement; hand movement; foot movement), measuring the conversion rate (number of user interactions with a particular product vs number of sales of the particular product), detecting interactions with the electronic label 2 via the user application device. It will be appreciated that this list of user interactions is not exhaustive and further user interactions may also be sensed.

The action performed by the electronic label 2 may include one or more of: generating a sensory output for a user from an output device, transmitting a communication to a user application device to cause a sensory output thereat and transmitting the sensed data to a remote resource. It will be appreciated that this list of actions is not exhaustive and further actions may be performed.

FIG. 2a schematically shows an example power rail 50 for powering an electronic label 2; FIG. 2b schematically shows a side view of the electronic label 2 having an attachment mechanism for attaching the electronic label to the power rail 50; and FIG. 2c schematically shows a rear view of the electronic label 2 having an attachment mechanism for attaching the electronic label 2 to the power rail 50.

The power rail 50 comprises a plurality of power blocks 51a-51c electrically coupled together (e.g. daisy chained), each power block 51 having a positive (+) rail 53 and a negative (−) rail 54. In the present illustrative example, the (+/−) rails are low-voltage DC rails (e.g. 5v-24v), although the claims are not limited in this respect.

In the illustrative example, of FIG. 2a, the power block 51c comprises a power connecter 52 to an AC power source, whereby the power block 51c also comprises AC to DC converter circuitry (not shown) to generate the appropriate output for the electronic labels. It will be appreciated that the power connector 52 may be a connector for a DC power source in which case the power block would not require the AC to DC converter circuitry.

Furthermore, although depicted as a plurality of power blocks in FIG. 2, in other examples the power rail may comprise a single power block.

As illustratively shown in FIGS. 2b and 2c, the electronic label 2 comprises connectors 55/56 depicted as male connectors in FIG. 2b, hereafter ‘pins’, which are inserted into the respective positive and negative rails on power rail 50.

In examples, the pins 55/56 are retractable into the body or casing of the electronic label 2, whereby for example the pins 55/56 are spring mounted such that operating (e.g. depressing) the release button 59 causes the pins 55/56 to retract into the body of the electronic label 2. It will be appreciated that the pins are illustrative only, and any suitable types of electrical connector may be used.

In other examples the electronic label 2 may be powered inductively and so may not have any exterior electrical connectors.

The body or casing of the electronic label 2 also comprises attachment means to retain the electronic label 2 relative to the power rail 50. In the present illustrative example, the attachment means comprises a magnetic coupling, whereby magnets 58a are used to magnetically couple the electronic label 2 to a ferromagnetic material 58b provided on the power rail 50. However, the claims are not limited in this respect and in other examples the attachment means may comprise, for example, an adhesive, a hook and eye mechanism (e.g. Velcro®), a mechanical coupling etc.

FIG. 3 schematically illustrates a system 1 having electronic labels 2a-2c.

The electronic labels 2a-2c may communicate with each other, for example using a wireless mesh network, although the claims are not limited in this respect.

The electronic labels 2a-2c communicate with remote resource 15 in the system 1, whereby remote resource 15 may comprise one or more services, which may be cloud services, applications, platforms, computing infrastructure etc.

The remote resource 15 may be located on a different network to the electronic labels (e.g. on the internet), whereby the electronic labels connect thereto e.g. via a gateway (not shown). However, one or more of the services may be located in the same network as the electronic labels 2a-2c (e.g. running on a server in the same WLAN).

In the present illustrative example, the remote resource comprises management service 15a and application service 15b, but this list is not exhaustive, and the remote resource may comprise other services.

Management service 15a is used to provision the respective electronic labels 2a-2c with device data such as firmware data, authentication data, registration data and/or update data (e.g. updates to firmware or authentication data).

The application service 15b performs analytics on the device data (e.g. sensed data) received thereat to generate analytics results based on or in response thereto. The application service 15b may also process the device data received from the electronic labels and comprise AI to perform machine learning, deep learning or neural network analysis thereon, and may also comprise a logic engine to take an action in response to processing the device data. Such an action may comprise sending a command communication comprising an instruction(s) or request(s) to an electronic label, an electronic signage device and/or a third party e.g. to a user application device.

Such a resource 15 may be provided as part of the MBED platform by ARM® of Cambridge (UK) although the claims are not limited in this respect. As above, the electronic labels 2 may connect to the resource 15 via one or more further resources (e.g. gateways). Such a gateway may comprise the MBED Edge platform provided by ARM®. In some embodiments the gateway provides an execution environment and compute resources to enable processing of data at the gateway itself.

A third party, for example, one that may be interested in the analytics results and/or communicating with one or more electronic labels and/or user application devices (hereafter “interested party”), can access the analytics results whereby, for example, the application service 15b communicates the analytics results directly and/or the sensed data to an application device 16 associated with the third party or to storage associated with an account registered to the interested party such that the interested party may access the analytics results using an application device 16 (e.g. by accessing the account via a user interface (UI) on the application device). Such analytics results may include a pivot table(s) or a graphical representation of the device data (e.g. a visual heatmap(s)).

It will be appreciated that in the context of the present description, an interested party may be one or more humans (e.g. store owner, product supplier, advertiser etc.) or an interested party may one or more applications or programs executed by an application device. For example, the application device may comprise artificial intelligence (AI) to perform machine learning, deep learning or neural network analysis on the sensed data and/or analytics results and may also comprise a logic engine to take an action in response thereto.

The interested party can, using the application devices 16, communicate with one or more of the electronic labels 2a-2c via remote resource 15, whereby an interested party may cause a command communication to be transmitted from the application device 16 to one or more of the electronic labels 2a-2c.

As an illustrative example, an interested party can, on interpreting the analytics results, send a command communication instructing electronic label 2a to generate a sensory output such as to, for example, adjust the price on the display, show a particular video on the display, update a barcode on the display, cause one or more lights to flash and/or cause a sound to be emitted although this list is not exhaustive.

In a further illustrative example, the electronic labels 2a can transmit device data to the application device 16 such that the interested party could, via a UI thereon, monitor or check the status of a particular electronic label (e.g. what information is currently shown on the display; which lights are currently flashing; what sound is being emitted).

In another example, the electronic label 2, remote resource 15 or interested party may transmit a communication to a user application device to cause a sensory output at the user application device (e.g. to display a price, a recipe or a discount voucher, a stock level etc.). For example, the application service 15b may transmit the sensed data to the interested party, whereby the interested party may process the sensed data to perform machine learning, deep learning, neural network analysis thereon, and the logic engine may cause the command communication to be transmitted to the user application device in response to the analysis.

In a further illustrative example, the electronic label or remote resource may determine that a user requires assistance (e.g. due to dwell time at a product being above a threshold (e.g. 2 mins) or determining that the user has traversed the same aisle a number of times without picking up a product). The electronic label or remote resource may transmit a command communication to the user application device to cause a sensory output to determine if the user requires assistance (e.g. a text message “Do you require assistance?”). The user can provide an input (e.g. via a touchscreen at the user application device), whereby the response is transmitted to the resource 15, and whereby the resource will send a command communication to an interested party (e.g. an application device associated with a store worker) to inform that party that the user requires assistance. The system 1 may also comprise a bootstrap service 15c to provision device data onto the various electronic labels 2a-2c. In the present illustrative example, bootstrap service 15c is provided as part of the management service 15a, but it may be a separate service (e.g. a cloud service).

Each electronic label 2a-2c may be provisioned with bootstrap data at manufacture, such as an identifier or an address for the bootstrap service 15c, to enable the electronic label to communicate with the bootstrap service 15c when first powered on, so as to receive the appropriate device data therefrom.

The bootstrap data may also comprise authentication data to enable the electronic label to authenticate itself with the bootstrap service 15c. The authentication data may comprise a cryptographic key (e.g. a private key) or a certificate, which may be from a trusted authority. Such functionality provides that only electronic labels having such authentication data will be able to connect with the bootstrap service 15c and may reduce the likelihood of rogue devices connecting therewith.

The device data received from the bootstrap service may comprise firmware and may also comprise an identifier or an address for one or more resources/services with which the electronic label should communicate with.

In examples, the device data received from the bootstrap service may be cryptographically signed (e.g. using a private key of the bootstrap service) such that the electronic labels 2a-2c can verify the device data as being from a trusted source using corresponding authentication data provisioned thereon (e.g. a public key or certificate of the bootstrap service). If an electronic label cannot verify a signature on received communications, it may disregard such communications. Therefore, the electronic labels 2a-2c may only accept, process and/or install data that has been verified as being from a trusted source. The cryptographic keys for communicating with bootstrap service may be provisioned on the respective electronic labels at manufacture, for example. It will also be appreciated that the electronic label can encrypt communications transmitted to the bootstrap service using the public key of the bootstrap service.

As described with respect to the bootstrap service above, the electronic labels may also be provisioned with authentication data for other remote resources (e.g. the management service, application service, application device(s) and/or electronic label(s)).

The authentication data may comprise a public key or certificate for the respective remote resources, and may be provisioned thereon, for example, by the bootstrap service as part of the bootstrap process, or as part of a registration process with the management service 15a or application service 15b.

Such functionality provides for different levels of access to the respective electronic label by different resources.

In an illustrative example, command communications signed using a first cryptographic key may authorise the resource signing the command communication to modify the display on a particular electronic label, whilst command communications signed using a second cryptographic key may authorise the signing resource to request sensed data from the electronic label, but not to modify the display. A third key associated with the management service may provide unrestricted control of the electronic label.

Therefore, on receiving communications from a remote resource, the electronic label can, in a first instance, verify whether the remote resource is authorised to communicate therewith, and, in a second instance, verify that the remote resource is authorised to request the instructions in the communications to be performed.

The system 1 may also comprise a registry resource to manage the identifier data on the various electronic labels, whereby managing the identifier data may include generating, maintaining and/or disbanding the identifier data as appropriate. The registry resource can generate the identifier data and transmit it to another remote resource (e.g. a manufacturer) for provisioning on an electronic label. Such a registry resource may be provided as part of the management service 15a.

The communications between the electronic labels 2a-2c, the remote resource 15 and/or the application devices 16 may be provided with end-to-end security, such as transport layer security (TLS), datagram transport layer security (DTLS) or secure socket layer (SSL). As above, the authentication data (certificates/keys) required for end-to-end security may be provisioned on the electronic labels 2a-2c, application service 15b and application devices 16 by, for example, the management service 15a.

The management service 15a may also provide the user application devices with authentication data for communicating with the electronic labels, the remote resource and/or further application devices using end-to-send security.

Communications transmitted between the labels, resources and/or one or more parties may undergo a cryptographic operation using the authentication data (e.g. encryption/signing) to provide the end-to-end security.

Such end-to-end security reduces the likelihood that the device data or the analytics results will be accessed by an unauthorised party.

The electronic labels 2a-2b may automatically determine their respective location or positions in a particular area by communicating with each other using a location determination protocol such as a MESH protocol, provisioned thereon during the bootstrap process.

As an illustrative example, when an electronic label is replaced, the replacement electronic label is powered on and it executes its bootstrapping process and is provisioned with device data comprising a location determination protocol, such that it resolves its location by communicating with other electronic labels or devices. The replacement electronic label can then communicate its location to the management service 15a which can provision the appropriate device data for its location thereon.

Similarly, when an existing electronic label is moved to a new location, it may determine its new location by communicating with electronic labels or devices at the new location and communicate its updated location to management service 15a so as to be provisioned with the appropriate device data for its new location.

In other examples, when a product(s) or product line at a particular location in the retail environment is updated or replaced, the management service 15a can communicate with the electronic label at the particular location so as to provision the electronic label with the appropriate information for the new product or product line.

Furthermore, when device data (e.g. firmware, authentication data) for a particular electronic label is updated, the management service 15a can communicate with the electronic label(s) so as to provision the electronic label with the updated device data.

Furthermore, an electronic label 2a can verify that other electronic labels 2b, 2c are operating as expected, whereby the electronic labels 2a-2c may transmit a status communication periodically (e.g. second(s), minute(s), hour(s) etc.). In the present illustrative example, the status communication comprises a ping, although it may take any suitable format.

An electronic label receiving the ping within a threshold timeframe can determine that the electronic label transmitting the ping is operating as expected.

When an electronic label does not receive an expected ping within the threshold time it can take appropriate action, such as sending a communication to the remote resource 15 warning that no ping was received. The remote resource 15 may then send a notification to an interested party (e.g. a store employee) to resolve any potential issue with the malfunctioning electronic label.

FIG. 4a schematically shows an example of an electronic label 2, whilst FIG. 4b schematically shows an example retail environment 20 having a plurality of electronic labels 2a-2f arranged on retail displays 21a & 21b (e.g. on shelves).

In FIG. 4b, each shelf 21a & 21b is depicted as having three different product lines 22a-22f, whereby each electronic label 2a-2f is associated with products of a respective product line 22a-22f. For example, electronic label 2a is associated with products in product line 22a, whilst electronic label 2f is associated with products in product line 22f.

Each of the electronic labels 2a-2f comprise a first sensor 11 of the sensor circuitry 10 (shown in FIG. 1) to detect user interaction therewith or with an associated product.

Each of the electronic labels 2a-2f also comprise an e-ink display 13 to output information to a user, such as product description information 17 (e.g. type, brand, a suggested recipe), machine readable information (e.g. a barcode for offline interaction) 18, and pricing information 19 (e.g. recommended retail price, sale price, price per item, price per kg, price per litre, tax total etc.).

However, the display 13 may output any suitable information to the user, and the information may be set, for example, in response to instructions in a command communication received from a remote resource (e.g. management service 15a, application service 15b and/or an application device 16).

The electronic labels 2 may be positioned/located on the shelves 21a & 21b by an authorised party, such as an employee of the retail environment, whereby the respective electronic labels automatically determine their locations when powered on as described above. It will be appreciated that a service with which the electronic labels 2a-2f communicate (e.g. management service) may maintain a database of the locations of various products on the different shelves, such that when an electronic label determines its location and communicates it to the management service 15a, the management service 15a can transmit device data for the products at that location to the electronic label. In examples, the device data for the products may include information to be shown on the display such as: pricing information, expiration dates, barcodes, special offers, quantity remaining in stock etc.

In alternative examples, when in position, an authorised party (e.g. an employee) may, via a UI on an application device or via a wired channel, provision the device data for the products at that location onto the electronic label 2a-2f.

In operation, a user of the retail environment (e.g. a customer) will interact with the various products or electronic labels 2 in various ways. For example, a user will pick-up a product if determined to be suitable for his/her needs. Such a determination may be made based on the product itself (e.g. branding) or the decision to pick-up, or not, may be made based on the information on the associated display (e.g. pricing information, a recipe shown on the display, a video shown on the display, a sound emitted etc.). In other cases, the user may simply examine the product (e.g. the branding/ingredients/calorific content) to check whether it is suitable, and, if not, the user will replace the product on the shelf. In other cases, the user may interact with the electronic labels via user application device (depicted as 16b in FIG. 4b).

The sensor 11 generates sensed data in response to the user interaction, and the electronic label 2 will process the sensed data and generate a sensory output in response thereto. For example, on determining that a user's dwell time is greater than a threshold dwell time specified in the device data or on determining that a conversion rate is lower than expected, the electronic label 2 may adjust the price information on the display 13, or cause an LED to flash, or a sound to be emitted or to transmit a command communication to the user application device to cause a sensory output thereat. The user can then react to the sensory output, e.g. deciding to purchase the product in response to the updated price.

In another example a weight sensor (not shown in FIG. 4a) is provided on the shelf for each product line and in communication with the associated electronic label, such that when a user picks up one or more products, the associated electronic label will detect the reduction in weight and determine that the user has picked up the product. The electronic label 2 may then generate a sensory output. For example, the electronic label 2 may update a ‘quantity’ field on the display 13 based on a determination that a product has been picked up and/or, the electronic label 2 may transmit a command communication to the user application device to cause a sensory output thereat (e.g. to update a running cost of products which the user has picked up of the shelves and to display the price to the user).

Additionally, or alternatively, the electronic label may send a communication to the remote resource 15 indicating that a product has been removed, whereby the remote resource 15 can update a stock level database accordingly, from which stock levels of the product can be monitored and controlled appropriately. Such functionality is particularly useful to warn a store owner that the stock for a particular product should be replenished when a threshold stock is reached, whereby the store owner can manage stock level based on realtime stock levels. It will be appreciated that the stock level database may be provided on the remote resource 15, or it may be on a different resource in communication with the remote resource 15.

Additionally, or alternatively, on determining that the number of products in the product line is below a threshold number, the electronic label may generate an output such as adjusting a ‘price’ field on the display, thereby providing for dynamic pricing based on the sensed quantity. The display 13 may also show a counter indicating the duration for which the price is valid. In another example the display may detail the number of products remaining in the product line or in the store itself e.g. in a ‘stock remaining’ field on the display. In a further example, the electronic label may communicate, e.g. via the remote resource 15, the quantity remaining to an interested party (e.g. the store owner). Such functionality is particularly useful to warn a store owner that the stock for a particular product should be replenished when a threshold stock is reached.

In the illustrative example of FIG. 4b, zero products remain in the product line associated with electronic label 2e. Therefore, the electronic label 2 may indicate using a visual (e.g. flashing light) or audible output (e.g. buzzer) that the stock in the product line 22e should be replenished. In another example, the electronic label may communicate to an interested party that zero products remain, whereby the electronic label may communicate the information via the remote resource 15.

Furthermore, the electronic labels may detect misplacement or mispositioning of products by a user. As illustratively shown at FIG. 4c, when a user picks up a product from a first product line 22g, and replaces the product on a second product line 22f, the electronic label 2f will detect (using the sensor circuitry) that an unexpected product is placed in the associated product line 22f, and can indicate using a visual or audible output that an unexpected product is detected. In another example, the electronic label 2f may communicate to an interested party (e.g. via the remote resource 15) that an unexpected product is detected. The interested party can then take an action to replace the product in its correct position. In another example, the electronic label 2f may transmit a command communication to the user via the user application device to cause a message to be displayed requesting that the user replace the product at the correct location.

As an illustrative example, when a product is placed in a product line, the electronic label associated with that product line can determine that the product is mispositioned if its detected weight is different from the products allocated to that product line. Additionally, or alternatively, the electronic label may determine that a product placed in an associated product line is mispositioned therein if the electronic label does not first detect a product pick-up prior to detecting the product being placed in the product line.

The illustrative examples above generally describe the sensed data being processed locally at the electronic label 2, and the electronic label 2 taking an action in response thereto. Such functionality may be seen as local monitoring of user activity or interaction.

Additionally, or alternatively, the electronic label(s) may transmit the sensed data to remote resource 15 for processing the sensed data thereat. The remote resource 15 can then perform an action in response to the processed data, such as transmitting a command communication to the electronic label(s). Such functionality may be seen as remote monitoring of user activity or interaction.

Local monitoring on the electronic labels themselves may provide some advantages over remote monitoring at a remote resource, whereby, on processing the sensed data locally, the electronic label 2 may perform pre-programmed actions when specific sensed data is identified e.g. ‘display price A when average dwell time is less than XXseconds’; ‘flash RED LEDs when product quantity <YY’; ‘communicate temperature warning to service B when detected temperature >ZZ° C.’, ‘display price D when average conversion rate is less than 50%’.

However, transmitting sensed data to a remote resource for remote processing may also provide advantages over local processing, in that the processing burden on the electronic labels is reduced. Remote monitoring may also provide for more powerful processing of the sensed data to be performed, and allows for aggregating data from a plurality of electronic labels and performing various analytics thereon to provide analytics results, whereby the electronic labels and/or user application devices can be controlled by transmitting command communications from the resource and/or one or more interested parties based on or in response to the analytics results and/or the sensed data.

FIGS. 5a-5c schematically show examples of analytics results generated by a remote resource 15 in response to processing the sensed data. The analytics results may be provided on a display at the application device of an interested party.

FIG. 5a schematically shows analytics results for a retail environment 30 with multiple aisles 31 having shelving 32, the shelving 32 having electronic labels associated with different product lines as described above. FIG. 5b schematically shows analytics results for a single aisle 31 of retail environment 30, with shelving 32 on either side thereof, whilst FIG. 5c schematically shows analytics results for a single aisle 31 with shelving 32 in retail environment 30. In the present illustrative example, the shelving 32 has electronic labels 2 (shown in FIG. 5c) associated with different products.

The electronic labels 2 on the shelving detect inter alia user interaction with respective product lines and transmit the sensed data to remote resource 15.

The remote resource 15 performs analytics in response to the sensed data and generates an output, which, as illustratively shown in the examples of FIGS. 5a-5c is a visual heatmap showing the user activity or interaction in the retail environment 30.

In the present illustrative examples, the visual heatmaps are overlaid on the pictures of retail environment 30, whereby the “hot” darker zones, some of which are illustratively indicated at 34, are indicative of higher user interaction in comparison to the “cool” lighter zones, some of which are illustratively indicated at 36.

An interested party may then (e.g. using AI) interpret the analytics results and take an action as appropriate. For example, a store owner may adjust the price of the products in the areas of lower user interaction 36. As described above, such adjustments to the price may be effected remotely in realtime.

Additionally, or alternatively, a store owner may physically redistribute goods around the retail environment in response to the analytics results such that the “hot” zones are more evenly distributed around the retail environment 30.

It will be appreciated that the analytics results could be generated for different user interactions (E.g. dwell time, conversion rate, product pick-up etc.), and for other sensed data such as temperature, humidity etc.

It will be appreciated that analytics results could also be generated for differing levels of granularity of sensed data from one or more electronic labels.

For example, an interested party may select (e.g. filter) sensed data from electronic labels associated with a particular product(s), a particular class of product(s) (e.g. beverage, chocolate, salad etc.), or for products of a particular brand owner.

Additionally, or alternatively, the interested party may select sensed data from different times of day, week, month, year etc., so as to identify trends during certain periods of the day or during certain holidays.

Additionally, or alternatively, the interested party may select sensed data from electronic labels within a single retail environment e.g. for a particular shelf(s), aisles(s), or select sensed data from electronic labels within two or more retail environments in a shopping centre(s), town(s), city(s) or country(s)) etc.

The analytics results and/or sensed data may also be subjected to analysis by machine learning, deep learning, neural networks or hive mind analysis to identify patterns or trends therein and an action taken in response.

In an illustrative example, the sensed data may indicate that there is a surge in pick-ups of a particular product during the same period of time every day. An interested party, on identifying the surge may, via a UI on the application device, tailor the information shown on a display in the store at the time of the surge (e.g. at one or more electronic labels or devices) so as to further maximise sales.

In a further illustrative example the analytics results and/or sensed data may indicate that there is an increased dwell time or reduced conversion rate for a product having new branding applied thereto, indicative that users cannot immediately decide to purchase the product. An interested party, on identifying the increased dwell time or reduced conversion rate may, via a UI on the application device, cause the electronic label associated with the product to display different information to identify the reason for the increased dwell time or reduced conversion rate. The interested party could then monitor the effect that the different information has on the dwell time or conversion rate for the product by monitoring the sensed data transmitted from the electronic label having the different information.

The interested party could reduce the price shown on the display of the associated electronic label and identify the effect the price reduction has on the dwell time or conversion rate.

Additionally, or alternatively, the interested party could cause the display on the electronic label to show other information (e.g. a video, recipe, barcode) and, as above, monitor the resultant dwell time or conversion rate, or cause a light to flash or sound to be emitted from the electronic label and to identify the effect, if any, such information has on the dwell time or conversion rate.

In other examples, the analytics results or the sensed data may be transmitted to further interested parties, such as brand owners, advertisers, product manufacturers to act in accordance with the analytics results or the sensed data.

For example, on identifying that dwell time for a particular product is higher than expected or that conversion rate is lower than expected, the brand owner may modify the branding for the product. Or on identifying that pick-ups of a particular product are reducing or slowing in a certain area of a town or city, the advertisers may generate a marketing campaign for that product to be displayed on billboards in that area of the city. In a further illustrative example, an interested party may send a command communication to the electronic label (e.g. via an application device) to modify information shown on the display (e.g. to reduce the price thereof, or to generate a new QR barcode for offline interaction). In other examples, the interested party may cause the electronic label to show a particular video or display a new recipe. As detailed above, each interested party may sign a command communication sent to the electronic label, for verification that the interested party is authorised to request a particular action.

An interested party may also transmit targeted messages to one or more users based on or in response to the analytics results and/or sensed data.

FIG. 6 schematically show an example of further sensor circuitry comprising sensors in the form of cameras 40a & 40b, each of which is arranged to sense a user interaction with respective products associated therewith.

As illustratively depicted in FIG. 6, the electronic labels comprise cameras 40a & 40b arranged above shelving 32 (e.g. on a gantry). In the present illustrative example, each camera 40a & 40b is a computer vision camera arranged to provide coverage for a designated area 42a & 42b of the shelving.

Each designated area 42a & 42b is divided into a grid system having a plurality of grid cells 44a & 44b, whereby each grid system is customisable for height, width and grid cell interval. A product or product line may be allocated to one or more of the grid cells, whereby the cameras 40a & 40b can detect user interaction with a product. In an illustrative example, when a camera 40a/40b senses a user's hand travels from inside a grid cell(s) to outside the grid(s) with a product, this interaction will be a determined to be a pick-up. Conversely, when the camera 40a/40b senses a user's hand travelling from outside the mesh grid to inside the mesh grid with a product, this interaction will be a determined to be a replacement of the product.

As above, the electronic labels transmit the sensed data to remote resource 15 which generates analytics results as discussed above.

Furthermore, it will be appreciated that the cameras 40a/40b may be used in combination with other sensors on the electronic labels as described above (e.g. motion sensors, weight sensors, light sensors).

Furthermore, whilst the cameras 40a/40b are described as being positioned above the shelving, the claims are not limited in this respect, and cameras may be located at any suitable position and may be integrated within individual electronic labels on each shelfs.

In embodiments, sensed data from one or more camera(s) may be used to identify one or more characteristics of a user such as the user's gender, age, height, shoe size, weight, waist size, hairstyle, gait, clothes worn by the user.

As an example, when the camera(s) captures an image of a user (i.e. generates sensed data), image data in the sensed data is processed to detect object features therein. Such object features may include: lines, edges, ridges, corners, blobs, textures, shapes, gradients, regions, boundaries, surfaces, colours, shadings, volume etc. The detected object features can then be used to identify the user characteristics, for example, by searching a data store (e.g. a modelbase) comprising object features of known user characteristics (e.g. user characteristic templates) against which the detected object features are compared to identify a match.

A sensory output can then be generated based on or in response to the identified user characteristic(s). For example, a determination can be made (e.g. by the electronic label or resource) as to which user demographic(s) the user falls into based on the identified characteristic(s), and cause a sensory output for that user demographic to be displayed in proximity to the user (e.g. at one or more electronic labels in proximity to the user, at a display (e.g. electronic signage) in the store, or at the user application device 16b associated with the user).

As an illustrative example, the sensed data may be processed to detect object features to identify the hairstyle of the user, and determine that the user is male, and generate a sensory output targeted for males. (e.g. cause an advertisement targeted for males to be shown at a display on one or more electronic labels in proximity to the user, at a display (e.g. electronic signage) in the store, or at the user application device 16b).

As a further illustrative example, the sensed data may be processed to detect object features to determine an approximate age of the user and generate a sensory output targeted for the user demographic in that age range (e.g. cause an advertisement directed for males aged 30-35 to be shown at a display on one or more electronic labels in proximity to the user, at a display (e.g. electronic signage) in the store, or at the user application device 16b).

It will be appreciated that, in some embodiments, whilst the sensed data may be used to determine which user demographic(s) the user fits into, the sensed data may not identify the user, and the user will remain anonymous.

In some embodiments, the sensed data may be used to identify the user, whereby, in an illustrative example, the user creates a profile by registering their face or body with the application service (e.g. using an application device at the retail environment or via the user application device). The sensed data can then be compared against the registered profile, and the user identified when the sensed data matches data registered for that user. Sensory outputs targeting the identified user can then be generated (e.g. communications sent to the user application device 16b associated with that identified user).

Cameras placed around the retail environment can also track the identified user as the user progresses around the retail environment, whereby the behaviour of the user can be monitored (e.g. dwell time, pick-ups etc.) and different sensory outputs generated at the electronic labels or transmitted to the user application device 16b associated with the user based on or in response to the user behaviour.

For example, as the identified user interacts with a product, the display on the associated electronic label may be updated to show information personalised for the user (e.g. a price may be updated for the user, or an advert specific to the user's gender may be shown, or a recipe may be shown, or a QR code for offline interaction may be shown, or a command communication transmitted to the user application device 16b associated with the user, e.g. via cellular communications (e.g. SMS) or internet-based (IM) messaging (e.g. WhatsApp; Twitter; Facebook; Instagram etc.), whereby the contact details may be obtained from the user's profile).

In a further illustrative example, the total cost payable for goods picked up by a tracked user is automatically calculated based on the sensed data generated as the user progresses around the retail environment. Cameras at the checkout may recognise the user and present the total cost to the user for settlement on a display at the checkout. In another illustrative example, the total cost payable will be automatically deducted from the user's store account so the user can proceed to the exit without queueing to pay. Such functionality will significantly reduce the time spent queueing and scanning goods at the checkout. Furthermore, the running cost may be updated at the user application device 16b associated with the user as the user progresses around the retail environment.

In a further illustrative example, the electronic labels may detect misplacement or mispositioning of products, whereby when a user picks up a product from a first product line and replaces the product on a second product line, the electronic label will detect using a camera associated with the second product line, that an unexpected product is placed in the second product line. The electronic label can then indicate that an unexpected product is detected by, for example, generating a visual or audible output and/or by communicating to an interested party (e.g. via the remote resource 15 to device 16a) that an unexpected product is detected. The interested party (e.g. the store owner or the user) can then take an action to replace the product in its correct position.

In an illustrative example, a camera may track or count the number of pick-ups and replacements for a particular grid or product line, and when the number of replacements is greater them the number of pick-ups, it will be determined that there is a misplaced item in the associated grid or product and the electronic label can indicate that an unexpected product is detected.

It will be appreciated that processing of the sensed data and identifying the user characteristics may be performed using the processing circuitry at the electronic label itself, whereby each electronic label comprises a data store in storage circuitry. Such functionality may reduce the communication requirements on the electronic label. Additionally, or alternatively, the sensed data may be transmitted from the electronic label to the remote resource 15 for processing and identifying the user characteristics. Such functionality may reduce the processing requirements on the electronic label, as the image processing will be performed remote therefrom.

Furthermore, the electronic label and/or the resource may be provided with AI functionality (E.g. machine learning, deep learning, neural networks) to determine the appropriate sensory output to generate in response to the identified user characteristic.

The cameras may also capture images of the products on the product lines and/or when a user interaction is detected, whereby in a further illustrative example, when a camera captures an image (e.g. of a product line or when a product is detected being replaced), image data in the captured image is processed to detect object features therein. Such object features may include: lines, edges, ridges, corners, blobs, textures, shapes, gradients, regions, boundaries, surfaces, colours, shadings, volume etc. The detected object features can then be used to identify the product, for example, by searching a data store (e.g. a modelbase) comprising object features of known products (e.g. templates) against which the detected object features are compared to identify a match. When the identified product is determined to be an unexpected product for that grid or product line, the electronic label can indicate that an unexpected product is detected.

It will be appreciated that processing of the image data and product identification may be performed using the processing circuitry at the electronic label itself, whereby each electronic label comprises a data store in storage circuitry. Such functionality may reduce the communication requirements on the electronic label. Additionally, or alternatively, the image data may be transmitted from the electronic label to remote resource 15 for processing and product identification. Such functionality may reduce the processing requirements on the electronic label, as the image processing will be performed remote therefrom.

FIG. 7 illustratively shows an example of analytics results generated in response to processing the sensed data generated by the cameras.

The user interactions with products are detected by cameras of associated electronic labels as the user progresses around the retail environment (e.g. picking up products, replacing products and examining products.)

The sensed data generated by the electronic labels is transmitted to the remote resource, which generates analytics results detailing the user's interactions with the products whereby the analytics results may detail user activity, for example: the sequence in which the user picked up the products, the dwell time the user spent viewing each product etc.

Such analytics results may be presented as a virtual reality (VR) output or augmented reality (AR) output 45 as depicted in FIG. 7, whereby an interested party can view a virtual representation of the user's progress around the store.

As will be appreciated, interested parties may communicate with various electronic signage devices to generate content on a display thereon.

FIG. 8 schematically show examples of electronic signage devices 60/70, whereby electronic signage device 60 is depicted as signage fixed to structures (e.g. shelving, refrigerator units, promotion stands) within the retail environment, whilst electronic signage device 70 is depicted as portable signage and may be located around the retail environment, such as at the entrance thereof.

Each electronic signage device 60/70 comprises circuitry as previously described above in relation to the electronic labels, although it will be appreciated that the electronic signage devices may comprise more powerful compute capabilities (e.g. processing, storage capabilities etc) in comparison to an electronic label, and further comprises a larger display 62/72 (e.g. LCD or OLED) for presenting information to a user.

The electronic devices 60/70 communicate with remote resource 15 (e.g. via a gateway), and in the illustrative example of FIG. 8, the electronic devices 60 or 70 may also communicate with one or more electronic labels around the retail environment 30 (e.g. directly or via the remote resource 15).

In an illustrative example, an interested party can control the information shown on the respective displays 62/72 via an application device 16a by transmitting command communications thereto to change the information displayed. Furthermore, the information shown on the respective display 62/72 may be controlled by the electronic labels 2, by transmitting command communications thereto.

For example, in response to detecting an increased average dwell time or reduced lower conversion rate for an associated product, an electronic label may transmit a command communication to the signage 60/70 to request that the respective display 62/72 shows a reduced price for the associated goods, or to request that the respective display 62/72 shows a message that there is a certain amount of stock on the shelf. The command communication may be generated by a logic engine in response to machine learning, deep learning, neural network analysis on the analytics results or sensed data.

In another example, an interested party may cause, for example, an advert or a recipe to be shown on a respective display 62/72 in response to the analytics results or sensed data.

In another example, the sensor circuitry on the electronic signage device 60/70 may detect user interaction (e.g. a user looking at the signage for a period of time) and generate an output in response to the sensed data.

As an illustrative example, as above, the sensor circuitry may comprise a camera which detects one or more characteristics of the user. The electronic signage device may then process the data to determine which demographic(s) the user falls into, and cause information to be displayed on the display 62/72 in response thereto.

In other examples, the electronic signage device 60/70 may transmit the sensed data to the remote resource for processing of the sensed data thereat. The remote resource may then transmit a command communication to the electronic signage device 60/70 to change the information displayed on the display 62/72 to provide a message targeted for the user.

The electronic signage device 60/70 and/or the remote resource 15 may also cause a sensory output to be generated at the one or more electronic labels in the retail environment in response to processing the sensed data (e.g. changing a price displayed by the label).

The electronic signage device 60/70 and/or the remote resource 15 may generate a command communication to cause a sensory output to be generated at a user application device 16b. As above, such a sensory output may comprise a targeted message to be displayed to the user and may comprise a code (e.g. a QR code) which provides a discount for the user, or the message may comprise product information about a particular product determined to be interesting to the user based on the demographic(s) which the user falls into. In an illustrative example, the targeted message may be transmitted directly from the electronic signage device 60/70 (e.g. via NFC. Bluetooth) to the user application device 16b, or the targeted message may be transmitted e.g. via cellular communications (e.g. SMS) or IM messaging.

Although depicted as signage in a retail environment in FIG. 8, the claims are not limited in this respect, and the electronic signage devices may also be electronic signage external to the retail environment (e.g. electronic billboards, display screens in a stadium etc.).

FIG. 9 is a flow diagram of steps in an illustrative process 100 in which the electronic label 2 generates a sensory output to which a user can react.

At step S101, the process starts.

At step S102, the electronic label is provisioned with bootstrap data to enable the electronic label to communicate with a bootstrap service when first powered on, so as to receive the appropriate device data therefrom. The bootstrap data may include an identifier or an address for the bootstrap service, and may also include authentication data (e.g. a cryptographic key).

At step S103, the electronic label is located in position in a retail environment and is powered on and performs the bootstrapping process, whereby the electronic label receives device data to enable it to communicate with a further resource, such as a service (e.g. a management or application service).

At step S104, the electronic label resolves its location by communicating with other electronic labels or devices in proximity thereto and using an appropriate location determination protocol (e.g. provided in firmware). The electronic label communicates its location to a remote resource, which, in turn, provisions the electronic label with the appropriate device data for its resolved location. In some examples the remote resource (e.g. a management service) will maintain a database of locations for different products or product lines in the retail environment, and provisions the electronic labels with the appropriate device data (e.g. firmware, protocols, authentication data) for each respective location.

At step S105, the electronic label senses a user interaction and generates sensed data in response thereto. Such a user interaction may comprise the user coming into proximity with an associated product; a user picking up/replacing an associated product; measuring a user's dwell time looking at an associated product (e.g. by detecting the user's presence in proximity to a product or by detecting a user's eyeball movements when looking at an associated product(s)). The sensed data may also comprise inputs from one or more cameras having facial recognition, facial detection or body feature recognition capabilities. The sensed data may also comprise interactions between the electronic label and a user application device.

At step S106a, the electronic label processes the sensed data locally (e.g. using machine learning, deep learning, neural network analysis) and at step 107 generates a sensory output comprising a visual or audible output(s)) from an output device(s) to which a user can react and/or the electronic label transmits a command communication to one or more electronic signage devices and/or to one or more user application devices to cause a sensory output to be generated thereat.

As described above, the electronic label may also comprise sensors to detect temperature, light and/or humidity sensors, the sensed data from which may also be processed at the electronic label and/or transmitted to the remote resource.

The electronic label may also perform other actions in response to the processed data, such as sending communications to an interested party (e.g. warning of stock levels falling below a set threshold; warning of a sensed temperature being above a set level etc.). The electronic label may also communicate with other signage devices to control the information displayed thereon.

Additionally, or alternatively, at step S106b the electronic label transmits the sensed data to a remote resource for processing the sensed data thereat. It will be appreciated that the remote resource may receive sensed data from a plurality of electronic labels in one or more retail environments.

At step S108, the remote resource processes the sensed data received from the electronic label(s) to generate an analytics result.

At step S109, the remote resource transmits a command communication to the electronic label, one or more other electronic labels, one or more electronic signage device and/or one or more user application devices to generate a sensory output (as at S107), in response to the analytics results and/or the sensed data (e.g. using machine learning, deep learning, neural network analysis).

At S110 the remote resource provides the analytics results and/or sensed data to an interested party (e.g. a store owner, a brand owner, an advertiser, AI etc.), whereby the analytics results and/or the sensed data may be accessed by the interested party via an application device. As set out above, such analytics results may include a pivot table(s) or a graphical representation of the data (e.g. as a visual heatmap(s)), or VR or AR outputs.

At step S111, an interested party transmits a command communication to the electronic label or one or more other electronic labels, an electronic signage device and or a user application device to generate a sensory output (as at S107), in response to processing the analytics results and/or sensed data (e.g. using machine learning, deep learning, neural network analysis).

At step S112, the process ends.

As above, the command communications from the remote resource or interested party may be signed using a cryptographic key, such that each electronic label can verify the signature whereby if a signature cannot be verified, the electronic label will ignore the command communications.

It will be appreciated that the sensed data generated by electronic labels is offline realtime data, whereby the sensed data provides information on user interactions with physical products in a physical retail environment in realtime. This differs to online data which provides information on user interactions with online stores (e.g. webstores).

The offline realtime data enables an interested party to perform analytics, and interact with the electronic label in response thereto. Such interactions with the electronic label include causing the electronic label to generate a sensory output to which users in the retail environment can react, and to identify, what if any effect the output has on subsequent user interactions substantially in realtime. Such functionality provides clear improvements over traditional product labels, which will only be scanned at a point of sale.

As above the electronic labels may be used in many different retail environments such as supermarkets, convenience stores, departments stores, pharmacies, coffee shops, book stores, shoe stores, clothes stores etc. although this list is not exhaustive. Similarly, the electronic labels may be associated with many different products including one more of: food, beverage, cosmetic, medicine, apparel and electronics goods, although this list is not exhaustive.

The electronic labels may also be used outside of the retail environment, such as in warehouses (e.g. sensing interaction with goods by a warehouse worker); in public houses (e.g. for sensing interaction by a member of the public with one or more drinks taps) and book libraries to name but a few.

Interested parties that access or use the device data (e.g. sensed data) from the electronic labels may include the owners of the retail environments or electronic labels, advertising firms, digital trade desks, marketing consultants, brand owners, media agencies, digital advertisement platforms, whereby the interested parties may all take actions in response to the analytics results. As an illustrative example, the advertising firms can tailor advertisements for certain goods in response to analytics results. Similarly, a brand manager can generate a barcode to be shown on the display which the user can scan for offline interaction.

It will be appreciated that sensed data collected by electronic labels or devices in one retail environment may be used by an interested party generate command communications for electronic labels, devices or user applications in a different retail environment. As an illustrative example, when a stock level for a product is detected to be at zero in first environment, the price of the product may be increased at a neighbouring retail environment. As a further illustrative example, when a user is determined to be interested in a product at a first retail environment (e.g. detected dwell time at a product is a above a threshold), then the price of that product may be reduced at a second retail environment when it is determined that the user has entered the second retail environment (e.g. using facial recognition).

It will also be appreciated that the electronic labels, electronic signage devices, remote resource and/or an interested party may also generate command communications based on or in response to further data other than the analytics results and sensed data described above.

As an illustrative example, the remote resource may take account of realtime weather data or forecasted weather data, whereby when it is raining, or forecast to rain, the remote resource can transmit a command communication to cause a display at an electronic signage device to indicate the aisle the umbrellas are located at, and transmit a command communication to all user applications devices in the retail environment (e.g. via a broadcast communication) to warn the user that it is raining or due to rain, and update the electronic labels associated with the umbrellas to increase the price of the umbrellas.

As a further illustrative example, when vehicle traffic is detected to be heavy in proximity to the retail environment (e.g. based on or in response to realtime traffic data), the remote resource or an interested party may transmit a command communication to all user applications devices in the retail environment to warn the user that traffic is heavy in the area, and cause advertisements for a restaurant or coffee shop to be displayed at electronic signage devices around the retail environment, whilst command communications which cause a discount code for the restaurant to be transmitted to the user application devices.

A user traversing the retail environment may use a carrier apparatus into, or onto, which one or more products are placed. Such a carrier apparatus may comprise a basket into which a user can place products, a cart on which a user can place products, or a rail on which a user can hang products (E.g. a clothes rail) etc.

FIGS. 10a-10c schematically show examples of a carrier apparatus 100 whereby in FIG. 10a the carrier apparatus 100 comprises a basket 100, whereby the basket 100 is part of a trolley 101, which a user pushes around a retail environment. However, the carrier apparatus may also be held by a user, whereby, as depicted in FIGS. 11a-11c, the carrier apparatus comprises a basket 200 comprising handles 201.

The baskets 100/200 have associated processing circuitry (not shown) for processing data.

The baskets 100/220 also comprise communication circuitry 106 for communicating with one or more resources remote therefrom such as an electronic label 2, user application device (e.g. a mobile phone or tablet), computer terminal, service (e.g. cloud service), gateway (not shown) etc. As depicted in FIGS. 10c/11c the basket may communicate with remote resource 15, which is described in detail above. The communication circuitry 106 may be used to pair the user with a particular basket, for example by performing a pairing operation by exchanging communications between the basket and user application device. However, the claims are not limited in this respect and in other illustrative examples, the user may be paired with a basket by scanning a code 107 associated with the basket (e.g. a QR code, or barcode). In other examples, the user may be paired with the basket using one or more cameras having facial recognition, facial detection or body feature recognition capabilities to detect one or more characteristics of the user (e.g. using a camera vison system). As above, such characteristics may include the user's gender, age, height, shoe size, weight, waist size, hairstyle, gait, clothes worn by the user etc., although the claims are not limited in this respect.

The baskets 100/200 also comprise location determination circuitry (not shown), for example, a global positioning system (GPS) unit and/or an inertial motion reference unit to generate location data. The communication circuitry may function as the location determination circuitry by engaging in positioning operations with one or more devices in the retail store (e.g. electronic labels, BLE beacons, Wi-Fi routers etc), so as to generate location data. Such positioning exchanges may include RSSI (received signal strength indicator), time of flight (TOF) and/or round-trip time (RTT) operations using, for example, Bluetooth, BLE or Wi-Fi although this list is not exhaustive.

The location data generated by such location determination circuitry may be transmitted to the remote resource 15 which can track the basket as the user progresses around the store based on or in response to the location data. The location data may be transmitted continuously, periodically (e.g. every ‘N’ seconds), and/or following an event (e.g. a user interaction).

The baskets 100/200 also comprise sensor circuitry comprising the one or more cameras 102 to detect user interaction, wherein the cameras 102 are arranged on the basket 100/200 to detect when a product is placed into and/or removed from the basket 100/200 by a user. The basket 100/200 may generate product status data in response to detecting a particular user interaction, whereby the product status data may indicate whether the product was placed into or removed from the basket 100/200 by the user.

The present illustrative examples of FIGS. 10b-10c & FIGS. 11b-11c depict baskets 100/200 having four cameras 102 placed at each corner thereof, but the claims are not limited in this respect, and any number of cameras (e.g. between 1 and 10) may be provided at any suitable location on the baskets 100/200 to detect user interactions or products as will become apparent to a person skilled in the art. For example, one or more cameras 102 may be provided on the trolley 101, whilst one or more cameras may be provided on, or embedded in, the handle 201. Providing the camera(s) 102 on or in the handle 201 provides for ease of replacement of the cameras by replacing the handle.

In some examples, the cameras 102 are wide angled cameras and are arranged so as to cover all, or substantially all, of the internal area of the basket. In other examples, the cameras 102 may be narrowly focussed along a particular plane so as to only capture products passing through that plane, when placed into or removed from the basket 100/200 by a user.

When a product 108 is picked up and placed into the basket 100/200, the cameras 102 detect the user interaction and generate image data by acquiring an image of the product 108. In other examples, the cameras 102 may generate the image data by periodically acquiring an image of all products in the basket every ‘M’ seconds, for example.

The image data is processed to identify a product using suitable image recognition techniques.

As an illustrative example, the image data is processed to detect object features therein. Such object features may include: lines, edges, ridges, corners, blobs, textures, shapes, gradients, regions, boundaries, surfaces, colours, shadings, volume etc. As will be appreciated by a person of skill in the art, the volume of a product (e.g. its 3D shape) can also be calculated from images acquired by cameras arranged at known positions and angles, whereby the volume is detected as an object feature. The detected object features are then used to identify the product, for example, by searching a data store (e.g. a modelbase) comprising object features of known products (e.g. templates) against which the detected object features are compared to identify a match.

Processing of the image data and product identification may be performed using the processing circuitry at the basket 100/200 itself, whereby each basket comprises a data store in storage circuitry. Additionally, or alternatively, the image data may be transmitted from the basket 100/200 to remote resource 15 for processing and product identification (e.g. using AI to perform machine learning, deep learning, neural network analysis).

It will be appreciated that transmitting the image data from the baskets 100/200 for remote processing and product identification means that the processing, storage and/or power requirements of the baskets may be reduced in comparison to baskets on which the image data processing and product identification is performed.

It may be possible to reduce the processing burden at the remote resource 15 by reducing the size of the image data prior to transmission from the basket, such that only a portion or subset of the acquired image is transmitted to the remote resource 15.

For example, the acquired image may be cropped at the basket to only include the most recent product placed into the basket, with other products already in the basket cropped from the image. As a further example, the processing circuitry may detect a particular feature(s) of the product and crop the acquired image so as to only transmit image data for that feature(s), whereby the feature may comprise text or graphics (such as a product logo), or machine readable code (such as a barcode or QR code).

The basket 100/200 may, along with the image data, transmit product status data to the remote resource 15 indicating that the product was placed into the basket.

When a product is identified, the remote resource 15 or basket 100/200 can take an appropriate action in response to the identified product.

Such an action may be to determine a cost payable for the identified product (e.g. as determined from a cost database at or in communication with the remote resource) such that the cost payable for all the products in the basket can be calculated as the user progresses around the store. The total cost for all products in the user's basket can then be provided to the user at an appropriate time, such as, for example, when purchasing is complete.

In examples, providing the total cost to the user comprises presenting the total cost on a display at a payment kiosk, at which the user can pay for the goods via a physical interaction at the kiosk e.g. using a debit/credit card or cash. Alternatively, providing the total cost to the user comprises automatically charging the user without requiring physical interaction with the user. For example, the user may have a store account with which the user's payment details are registered (e.g. a debit card, credit card, bank or payment account etc), whereby the total cost payable for the products is automatically deducted using the user's payment details. It will be appreciated that such functionality provides for a frictionless shopping experience for the user, whereby the user can enter a store, place one or more products from the store into a basket and walk out of the store without having to queue to pay for the goods, with payment automatically deducted using the user's payment details e.g. when the user is detected leaving the store or when the user indicates that it has completed purchasing (e.g. via a paired user application device).

Additionally, or alternatively, the action may include updating a stock level database, so that the staff of the retail store can manage stock levels and inventory in realtime.

Additionally, or alternatively, the action may include transmitting a command communication to the user application device to cause the user application device to generate a sensory output (e.g. displaying a running cost to the user; displaying a message to the user (e.g. a targeted advertisement for the user to “buy eggs”).

Additionally, or alternatively, the action may include displaying information relating to the product on a display on the basket (depicted as display 109 In FIG. 10b). Such displayed information may include pricing information e.g. showing the total cost payable for all products in the basket. The displayed information may additionally, or alternatively, include an advertisement for related products or any other suitable information. The basket may also transmit location data for the location at which the product was placed into the basket. The remote resource can use the location data to reduce the space of the data store which it has to search (search space), by only including object features for products at that location in the comparison against the object features detected in the image data.

In other examples, the search space may also be reduced in response to user data, whereby the resource may be aware of preferred products which the particular user purchases, and may only include the known object features of the preferred products in the comparison with detected products. If no product is identified from the reduced search, the search space may be extended to include known object features of non-preferred products (e.g. for all products in the store). Such user data may be collected based on previous purchases or may be based on user input via a user application device.

Furthermore, whilst the electronic labels described above in FIGS. 1 to 9 are indicative of user intent to purchase a particular product, the baskets described in FIGS. 10 and 11 provide further confirmation that the product was purchased, and this further confirmation of purchase can be provided to interested parties to take appropriate action (e.g. to update a display on a particular electronic label, to generate more accurate heatmaps for purchased goods, to generate promotional material, to generate tailored advertisements etc.).

Whilst the examples above generally describe a user placing a product into a basket, the cameras may also detect when a product is removed from a basket, and transmit image data for the removed product to the remote resource 15. The basket 100/200 may also transmit product status data to the remote resource indicating that the product was removed from the basket such that the remote resource can take an appropriate action such as updating the total cost payable for the remaining products in the basket accordingly, such that the user will not be charged for the products removed. Another action may be to update a stock level database to indicate that the product was not removed from the store.

As described above, the basket can also transmit location data for the location at which the product was removed from the basket, such that the remote resource can detect misplacement of products by a user.

As an illustrative example, when the user removes a product from a basket, the basket transmits image data, product status data and location data to the remote resource, which can identify the product and determine whether the product was removed at its expected location. If not, the remote resource can determine that the product is misplaced in the store following removal from the basket 100/200.

Such functionality may also be used in conjunction with electronic labels as described above, whereby a remote resource can identify the product and the location of the misplaced product in the store even when neither the basket nor the electronic label can identify the product. For example, the cameras on the basket may acquire an image of a product when a user removes it from the basket, and the basket may transmit the image data to the remote resource along with product status data and location data for the location at which the product was removed.

An electronic label at that location may also detect an unexpected product in an associated product line, and update the remote resource 15 accordingly as described above in FIG. 4c.

The remote resource 15 can then identify the product removed from the basket from the image data and determine that the identified product was misplaced in the associated product line. The remote resource 15 can then take an appropriate action.

For example, if the product is required to be maintained at a particular temperature (e.g. if the product is frozen fish, or fresh meat for example), and the current location of the product is not at the particular temperature (e.g. as determined from temperature data received from the electronic label), then the remote resource can transmit a signal to indicate that the store owner should take action to prevent the product from spoiling. In another example the resource can transmit a communication to the user application device to cause a sensory output to alert the user to replace the item in the correct location.

In a further illustrative example, the remote resource 15 may detect, from received location data, when a user abandons a basket, whereby when movement of a basket is not detected for a time period greater than a threshold time (e.g. 5 minutes), the remote resource 15 can take an appropriate action, such as to notify a store owner of the location of the abandoned basket so it can be retrieved. As the remote resource 15 will also be aware of the products in the basket, the remote resource can transmit a signal to indicate that the store owner should take action to prevent products spoiling (e.g. if the products are required to be stored at a particular temperature). In another example, the resource may communicate with the user to determine whether the user has purposely abandoned the basket (e.g. by having the user confirm that they are finished shopping).

As described above, the remote resource may perform analytics based on data received from electronic labels.

It will also be appreciated that the remote resource may also perform analytics on the data received from the baskets in addition or as alternative to the sensed data received from the electronic labels. For example, the remote resource may perform analytics in response to the image data, the product status data and/or the location data received from the baskets 100/200.

The analytics results in response to the data from the baskets may include a pivot table(s) or a graphical representation of the data (e.g. a visual heatmap(s)). The remote resource 15 may also process the data received from the baskets 100/200 to perform machine learning, deep learning or neural network analysis thereon, and may also comprise a logic engine to take an action in response to processing the device data. Such an action may comprise sending a command communication comprising an instruction(s) or request(s) to an electronic label (e.g. to generate a sensor output or adjust information displayed on the electronic label) or to another device (e.g. electronic signage (not shown) to display promotional material, a recipe, a message etc.). Such an action may comprise sending a command communication comprising a command communication to a user application device (not shown)

An interested party may also access the analytics results and perform an action in response thereto. For example, a store owner may adjust the price of the products in the areas of lower user interaction (e.g. using an associated application device (not shown)). As described above, such adjustments to the price may be effected remotely in realtime to provide dynamic pricing.

Additionally or alternatively the resource or an interested party may transmit command communications to a user application device based on or in response to the analytics results.

Additionally, or alternatively, a store owner may physically redistribute goods around the retail environment in response to the analytics results.

It will be appreciated that the analytics results could be generated for different user interactions detected by the cameras 102 (E.g. conversion rate, time a user spends in store, the route a user takes in the store etc.).

It will be appreciated that analytics results could also be generated for differing levels of granularity of data received from one or more baskets 100/200.

For example, an interested party may select (e.g. filter) data from baskets associated with a particular user (e.g. based on sex, age, wages etc, which may be provided by a user during a registration process with the store).

Additionally, or alternatively, the interested party may select data from different times of day, week, month, year etc., so as to identify trends during certain periods of the day or during certain holidays.

Additionally, or alternatively, the interested party may select data from baskets within a single retail environment e.g. for a particular shelf(s), aisles(s), or select data from baskets within two or more retail environments in a shopping centre(s), town(s), city(s) or country(s)) etc.

As above, the data may also be subjected to analysis by machine learning, deep learning, neural network or hivemind analysis to identify patterns or trends therein and an action taken in response thereto.

In an illustrative example, the analytics results may indicate that there is a surge in purchases of a particular product during the same period of time every day. An interested party, on identifying the surge may, via a UI on an application device, tailor the information shown on a display 107 or transmitted to a user application device so as to further maximise sales.

In a further illustrative example, the analytics results may indicate that there is a reduced conversion rate for a product having new branding applied thereto, indicative that users cannot immediately decide to purchase the product.

An interested party, on identifying the reduced conversion rate may cause an electronic label associated with the product to display different information.

The interested party could then monitor the effect that the different information has on the conversion rate for the product by monitoring the data received from the baskets and/or the sensed data received from electronic labels.

For example, the interested party could reduce the price shown on an electronic label and identify the effect the price reduction has conversion rate. Additionally, or alternatively, the interested party could cause a screen in proximity to a particular product to display advertising information (e.g. a video, recipe, barcode) and, as above, monitor the resultant conversion rate.

Additionally, or alternatively, the interested party may cause a light to flash on, or sound to be emitted from, an electronic label associated with the product to identify the effect, if any, such sensory output has on the conversion rate.

As above, the analytics results resulting from the user interactions detected by the baskets 100/200 may be transmitted to further interested parties, such as brand owners, advertisers, product manufacturers to act in accordance with the analytics results.

For example, on identifying that the conversion rate for a particular product is lower than expected, the brand owner may modify the brand. Or on identifying that purchases of a particular product are reducing or slowing in a certain area of a town or city, the advertisers may generate a marketing campaign for that product to be displayed on electronic billboards in that area of the city. In a further illustrative example, an interested party may send a command communication to an electronic label associated with a particular product to modify information shown on an associated display.

FIG. 12 is a flow diagram of steps in an illustrative process 200 for a user using a carrier apparatus such as a basket of FIGS. 10a-c or 11a-c.

At step S201, the process starts.

At step S202, a user is paired with a basket. Such pairing may be via pairing operations between communication circuitry on the basket and a user application device. Alternatively the pairing may be provided by the user scanning a code on a basket (e.g. a QR code), or via facial recognition.

At step S203, one or more cameras on the basket acquire images of a product in response to a detected user interaction with the product, which may comprise a user placing the product into the basket or removing the product from the basket.

At step S204, the image data is transmitted to a remote resource for processing and image identification. The basket may also transmit product status data indicative of the user interaction and may further transmit location data relating to the location at which the user interaction occurred.

At step S205, the remote resource processes the image data and, using suitable image recognition techniques, identifies the product.

At step S206, the remote resource performs an action in response to the identified product and user interaction, whereby, for example, when it is determined that the user places a product into the basket then the cost payable for the product can be added to a total cost payable for all products in the basket and/or a stock level database updated accordingly.

Additionally, or alternatively, a command communication may be transmitted to a user application device based on or in response to the identified product and user interaction, whereby for example when it is determined the user places a product into the basket, a running cost total may be updated and presented to the user.

Alternatively, when it is determined that the user removes a product from the basket then the cost of the product is deducted from the total cost for the products in the basket, a stock level database may be updated accordingly, and/or the resource may determine whether a product removed from the basket was replaced at an expected location in the store, and, if not (i.e. misplaced), alert a store owner or the user (e.g. via the user application device) as appropriate.

At step S207 it is determined whether the user has completed all purchases. For example, the user may confirm via a user application device or a display on the basket that purchasing is complete. In other examples, purchasing may be determined to be complete when the user is detected exiting the retail store.

At step S208, when it is determined that purchasing is complete, the total cost is provided to the user. As described above, providing the total cost to the user may comprise presenting the total cost to the user for settlement via a physical interaction at a payment kiosk, or automatically charging the user without requiring physical interaction from the user for frictionless shopping.

When it is determined that purchasing is not complete, steps s203 to s206 are repeated.

At Step S209, the process ends.

Embodiments of the present techniques further provide a non-transitory data carrier carrying code which, when implemented on a processor, causes the processor to carry out the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier or on a non-transitory computer-readable medium such as a disk, microprocessor, CD- or DVD-ROM, programmed memory such as read-only memory (firmware), or on a data carrier such as an optical or electrical signal carrier. The code may be provided on a (non-transitory) carrier such as a disk, a microprocessor, CD- or DVD-ROM, programmed memory such as non-volatile memory (e.g. Flash) or read-only memory (firmware). Code (and/or data) to implement embodiments of the techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

Computer program code for carrying out operations for the above-described techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

In the preceding description, various embodiments of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter. As an illustrative example, the carrier apparatus is not limited to baskets, and may be any suitable apparatus for carrying products.

1. A method comprising:
receiving, at a first resource from an electronic device, a communication comprising sensed data based on or in response to sensing user interactions at the electronic device;
processing, at the first resource, the sensed data;
transmitting, from the first resource to the electronic device, a first command communication to generate a sensory output at the electronic device in response to sensed data.

2. The method of claim 1, further comprising:
transmitting, from the first resource, to a user application device a second command communication to cause the user application device to perform an operation at the user application device.

3. The method of claim 2, wherein the operation at the user application device comprises generating a sensory output targeted for the associated user.

4. The method of claim 1, wherein processing the sensed data comprises performing one or more of: machine learning, deep learning and neural network analysis thereon.

5. The method of claim 1, further comprising:
generating, using a logic engine at the first resource, the first command communication.

6. The method of claim 1, further comprising:
performing a cryptographic operation on the first command communication.

7. (canceled)

8. The method of claim 1, wherein processing the sensed data comprises:
processing image data in the sensed data to identify one or more characteristics of a user.

9. The method of claim 8, further comprising:
generating the first or second command communication based on or in response to the identified one or more user characteristics.

10. The method of claim 1 further comprising:
generating, at the remote resource, analytics results based on or in response to the sensed data.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. A method of responding to detecting user interactions at an electronic label, the method comprising:
sensing, at the electronic label, user interactions;
generating, at the electronic label, sensed data based on or in response to the sensed user interactions;
generating, using authentication data at the electronic label, a secure communication comprising the sensed data;
transmitting, from the electronic label to a remote resource, the secure communication;
receiving, at the electronic label from the remote resource, a secure command communication;
generating, at the electronic label, a sensory output based on or in response to the secure command communication.

23. The method according to claim 22, comprising one or more of:
processing the sensed data locally at the electronic label and transmitting the sensed data to a remote resource.

24. A system comprising:
a first resource in communication with one or more electronic devices, wherein the first resource receives sensed data from the one or more electronic devices, and
wherein the first resource transmits a first command communication to one or both of the one or more electronic devices and a user application device based on or in response to processing the sensed data.

25. The system of claim 24, wherein the first resource comprises artificial intelligence (AI) to perform machine learning, deep learning or neural network analysis on the analytics results and/or sensed data.

26. The system of claim 25, wherein the first resource comprises a first logic engine to generate the first command communication in response to the machine learning, deep learning or neural network analysis on the analytics results or sensed data.

27. The system of claim 24, further comprising:
generating, at the first resource, analytics results based on or in response to processing the sensed data.

28. The system according to claim 27 comprising:
a second resource in communication with the first resource to access the analytics results or sensed data at the first resource.

29. The system of claim 28, wherein the second resource comprises artificial intelligence (AI) to perform machine learning, deep learning or neural network analysis on the analytics results and/or sensed data.

30. The system of claim 29, wherein the second resource comprises a second logic engine to generate a second command communication in response to the machine learning, deep learning or neural network analysis on the accessed analytics results or sensed data.

31. (canceled)

32. The system of claim 24, wherein the electronic label comprises a camera to detect one or more characteristics of a user, wherein the camera comprises one or more of: facial recognition, facial detection or body feature recognition capabilities to detect the one or more characteristics of the user.

33. (canceled)

34. (canceled)

35. (canceled)

36. (canceled)

37. The system of claim 24, wherein the one or more electronic shelf labels are provided in a retail environment.

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)
